(19) United States
(12) Patent Application Publication
(10) Pub. No.: US 2026/0043826 A1
(43) Pub. Date: Feb. 12, 2026

(54) Method of Estimating Motor Speed and Motor Control System

(71) Applicant: Infineon Technologies Austria AG, Villach (AT)

(72) Inventor: Hamid Behjati Najafabadi, Los Angeles, CA (US)

(21) Appl. No.: 18/795,673

(22) Filed: Aug. 6, 2024

(51) Int. Cl. G01P 3/489; H02P 23/14

(52) U.S. Cl. CPC G01P 3/489; H02P 23/14

(57) ABSTRACT

A method of estimating motor speed includes: calculating a first estimate of rotor mechanical frequency of a motor based on measured time between successive counter pulses, each of the counter pulses corresponding to a fixed number of counts per revolution of the motor; calculating a second estimate of the rotor mechanical frequency based on the number of counter pulses over a fixed period of time; and dynamically revising an official estimate of the rotor mechanical frequency, by weighting the first and second estimates inversely proportional to one another based on the rotor mechanical frequency. A corresponding motor control system is also described.

### BACKGROUND

Incremental encoders are widely used in motor control applications for position and speed sensing. Incremental encoders provide high-precision position sensing in servo and robotics applications. Motor speed can be estimated based on position information provided by an incremental encoder. Conventionally, there are two methods for estimating motor speed based on encoder position information. The first method uses a timer/counter running at a fixed clock frequency to measure the time between count pulses which occur at each edge transition of the encoder quadrature signals. The second method measures the number of count pulses in a fixed period of time, usually the interrupt service routine (ISR) period of a motor control algorithm.

Both methods have quantization noise, with the first method being less noisy at lower frequencies and the second method being less noisy at higher frequencies. However, only the first method is typically used since incremental encoders are rarely used for high speed applications.

### SUMMARY

According to an embodiment of a method of estimating motor speed, the method comprises: calculating a first estimate of rotor mechanical frequency of a motor based on measured time between successive counter pulses, wherein each of the counter pulses corresponds to a fixed number of counts per revolution of the motor; calculating a second estimate of the rotor mechanical frequency based on the number of counter pulses over a fixed period of time; and dynamically revising an official estimate of the rotor mechanical frequency, by weighting the first and second estimates inversely proportional to one another based on the rotor mechanical frequency.

According to an embodiment of a motor control system, the motor control system comprises a controller configured to: calculate a first estimate of rotor mechanical frequency of a motor based on measured time between successive counter pulses, wherein each of the counter pulses corresponds to a fixed number of counts per revolution of the motor; calculate a second estimate of the rotor mechanical frequency based on the number of counter pulses over a fixed period of time; and dynamically revise an official estimate of the rotor mechanical frequency, by weighting the first and second estimates inversely proportional to one another based on the rotor mechanical frequency.

Those skilled in the art will recognize additional features and advantages upon reading the following detailed description, and upon viewing the accompanying drawings.

### BRIEF DESCRIPTION OF THE FIGURES

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 illustrates a schematic diagram of a motor control system, according to an embodiment.

FIG. 2 illustrates quadrature signals, a count signal, and a direction signal generated by an incremental encoder.

FIG. 3 illustrates a normalized quantization error and a normalized quantization error envelope for a first motor speed estimation method.

FIG. 4 illustrates a normalized quantization error and a normalized quantization error envelope for a second motor speed estimation method.

FIG. 5 illustrates a breakeven frequency point between the first and second motor speed estimation methods.

FIG. 6 illustrates an optimal weighting/blending curve for the first and second motor speed estimation methods.

FIG. 7 illustrates normalized error curves obtained by different weighting/blending methods described herein.

FIG. 8 illustrates a table of quantization error results obtained for an example encoder.

FIG. 9 illustrates a block diagram of an embodiment of a closed loop implementation of the motor speed estimation technique implemented by the controller.

FIG. 10 illustrates encoder signals and frequency parameters for an example encoder.

FIG. 11 illustrates a schematic diagram of the motor control system, according to another embodiment.

FIG. 12 illustrates hall signal patterns, count and direction signals derived from the hall signal patterns, and corresponding currents and voltages for the respective motor phases.

### DETAILED DESCRIPTION

Described herein are embodiments of a motor speed estimation technique having improved quantization noise performance over a wide rotor mechanical frequency range. The motor speed estimation technique may be used with incremental encoders or other types of sensors used to estimate motor speed such as hall sensors. Regardless of the type of encoder or sensor used, the motor speed estimation technique described herein weights/blends two different methods for estimating the motor speed based on sensed motor position information, to improve quantization noise performance over the target frequency range. The first method uses a timer/counter running at a fixed clock frequency to measure the time between count pulses derived from sensed motor position information. The second method measures the number of count pulses in a fixed period of time, e.g., the interrupt service routine (ISR) period of a motor control algorithm. The results of both methods are weighted/blended based on the rotor mechanical frequency of the motor, thereby dynamically revising an official frequency (speed) estimate that is used to control the motor. The output of the first method is weighted more heavily at lower frequencies and the output of the second method is weighted more heavily at higher frequencies.

The weighting, also referred to herein as blending or weighted blending, may be a binary decision. For example, if the rotor mechanical frequency is below a predetermined threshold, a weighting factor of one may be applied to the motor speed estimate produced by the first method and a weighting factor of zero may be applied to the motor speed estimate produced by the second method. If the rotor mechanical frequency is above the predetermined threshold, a weighting factor of one may be applied to the motor speed estimate produced by the second method and a weighting factor of zero may be applied to the motor speed estimate produced by the first method.

Instead of the binary approach, a linear or nonlinear weighting factor may be applied to the motor speed estimates produced by both methods. With this approach, as the rotor mechanical frequency increases, the linear or nonlinear weighting factor places greater emphasis on the motor speed estimate produced by the second method and less emphasis on the motor speed estimate produced by the first method. Conversely, as the rotor mechanical frequency decreases, the linear or nonlinear weighting factor places less emphasis on the motor speed estimate produced by the second method and greater emphasis on the motor speed estimate produced by the first method.

Described next, with reference to the figures, are exemplary embodiments of the motor speed estimation technique.

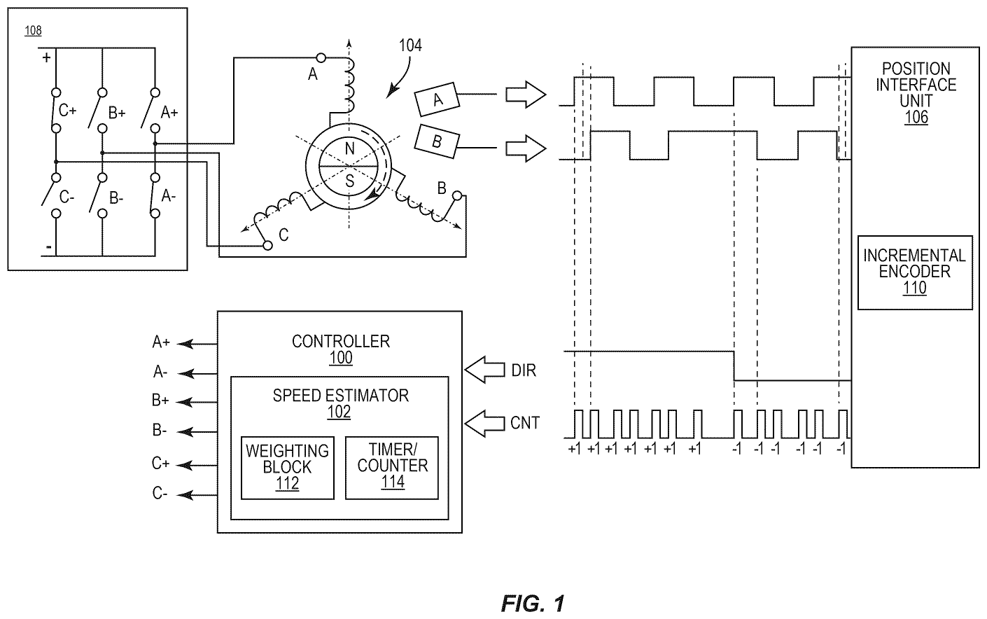

FIG. 1 illustrates a schematic diagram of a motor control system, according to an embodiment. The motor control system includes a controller 100 such as a microcontroller, microprocessor, CPU (central processing unit), AI (artificial intelligence) processor, etc. The controller 100 includes a speed estimator block 102 that calculates a first estimate \hat{f}₁ of the rotor mechanical frequency f* of a motor 104, based on a measured time n_{clk} between successive counter pulses CNT generated by a position interface unit 106. Each counter pulse CNT generated by the position interface unit 106 corresponds to a fixed number of counts per revolution of the motor 104.

The position interface unit 106 works with the controller 100 to enable accurate position and velocity measurement and to control the PWM (pulse width modulation) outputs (A+, A−, B+, B−, C+, C−) for controlling the different phases of the motor 104 via corresponding power switch device branches or legs 108. The motor 104 is shown with three (3) phases A, B and C and three (3) corresponding half bridge branches/legs in FIG. 1. More generally, the motor 104 may have two (2) or more phases and a corresponding number of half bridge branches/legs.

In FIG. 1, the position interface unit 106 uses an incremental encoder 110 as part of the motor speed estimation feedback loop. The incremental encoder 110 is a quadrature encoder that generates quadrature signals A and B. The A and B output signals are quadrature-encoded in that when the incremental encoder 110 is moving at a constant velocity, the A and B signals are square waves with a 90° phase difference between A and B. The phase difference between the A and B quadrature signals is positive or negative depending on the direction of movement of the incremental encoder 110. The frequency of the A and B quadrature signals is directly proportional to the velocity (i.e., rate of position change) of the incremental encoder 110. Accordingly, higher frequencies indicate higher motor speed and lower frequencies indicate slower motor speed. The incremental encoder 110 also outputs a directional signal DIR, which indicates a forward or reverse direction of rotation of the motor 104.

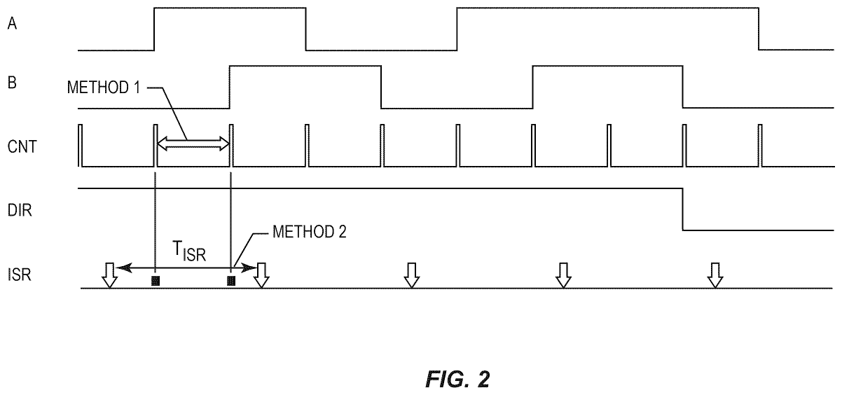

The speed estimator 102 of the controller 100 also calculates a second estimate \hat{f}₂ of the rotor mechanical frequency f* based on the number of counter pulses CNT over a fixed period of time. In one embodiment, the fixed period of time is the interrupt service routine (ISR) period of a motor control algorithm implemented by the controller 100. The controller 100 also includes a weighting block 112 that dynamically revises an official estimate \hat{f} of the rotor mechanical frequency f*, by weighting the first and second estimates \hat{f}₁, \hat{f}₂ inversely proportional to one another based on the rotor mechanical frequency f*. Accordingly, the first estimate \hat{f}₁ derived using the first motor speed estimation method is weighted more heavily at lower frequencies and the second estimate \hat{f}₂ derived using the second motor speed estimation method is weighted more heavily at higher frequencies. The controller 100 uses the official estimate \hat{f} of the rotor mechanical frequency f* to control the motor 104. Operation of the speed estimator 102 included in the controller 100 is described next in more detail with reference to FIG. 2.

FIG. 2 illustrates the A and B quadrature signals, the count CNT signal, and the direction signal DIR generated by the incremental encoder 110. FIG. 2 also illustrates the ISR timeline. FIG. 2 further illustrates the two (2) motor speed estimation methods implemented by the speed estimator 102, where the first method (‘method 1’) is implemented using a timer/counter 114 running at a fixed clock frequency f_{clk} and the second method (‘method 2’) counts the number of pulses CNT per fixed period of time, e.g., the ISR period T_{ISR}.

To analyze the quantization effects, the following mathematical conventions for representing an arbitrary variable, x, are provided:

$$\{ \begin{matrix}x * & real value , or reference value \\ \hat{x} & estimated value \\ \tilde{x} = x * - \hat{x} & estimated error \\ {\tilde{x}}^{env} & error envelope \\ {\tilde{x}}^{\%} = \tilde{x} / x * & normalized error \\ {\tilde{x}}^{\% , env} & normalized error envelope\end{matrix} \qquad ( 1 )$$

From FIG. 2, the estimated rotor mechanical frequency using either the first motor speed estimation method or the second motor speed estimation method, denoted by \hat{f}₁ and \hat{f}₂, respectively, can be shown to be:

$$\{ \begin{matrix}{\hat{f}}_{1} & = \frac{1 / {N}_{0}}{{n}_{clk} {T}_{clk}} = \frac{{f}_{clk}}{{n}_{clk} {N}_{0}} \\ {\hat{f}}_{2} & = \frac{{n}_{ISR} / {T}_{ISR}}{{N}_{0}} = \frac{{n}_{ISR} {f}_{ISR}}{{N}_{0}}\end{matrix} \qquad ( 2 )$$

where n_{clk} is the measured time between successive counter pulses CNT, N₀ is the fixed number of counts per revolution that depends on the encoder 110 and is a mechanical parameter that does not change, n_{ISR} is the number of counter pulses CNT over a fixed period of time which is T_{ISR} in this example (T_{ISR} being the ISR period), f_{ISR} is the frequency of the ISR period, and f_{clk} is the clock frequency of the timer/counter 114 that measures n_{clk}.

The fixed number of counts per revolution of the motor 104, No, is given by:

$${N}_{0} = C P R = 4 \cdot L P R \qquad ( 3 )$$

where CPR and LPR denote the number of counts per revolution and lines per revolution, respectively, for the incremental encoder 110 and are typically in the range of ˜1000.

From (2), n_{clk} and n_{ISR} can be calculated, given the actual rotor mechanical frequency f*, as follows:

$$\{ \begin{matrix}{n}_{clk} & = ⌊ \frac{{f}_{clk}}{{N}_{0} f *} ⌋ \\ {n}_{ISR} & = ⌊ \frac{{N}_{0} f *}{{f}_{ISR}} ⌋\end{matrix} \qquad ( 4 )$$

where └⋅┘ is the floor function, e.g. └2.85┘=2.

By combining (2) and (4), the first and second frequency estimates \hat{f}₁, \hat{f}₂ can be expressed in terms of real (or reference frequency) f* as follows:

$$\{ \begin{matrix}{\hat{f}}_{1} & = \frac{{f}_{clk} / {N}_{0}}{⌊ {f}_{clk} / ( {N}_{0} f * ) ⌋} \\ {\hat{f}}_{2} & = \frac{⌊ ( {N}_{0} f \text{*)} / {f}_{ISR} ⌋}{{N}_{0} / {f}_{ISR}}\end{matrix} \qquad ( 5 )$$

From (5), the following holds true:

$$\{ \begin{matrix}{\hat{f}}_{1} {\vert}_{f * \to 0} & = f * \\ {\hat{f}}_{2} {\vert}_{f * \to ∞} & = f *\end{matrix} \qquad ( 6 )$$

which implies that the first motor speed estimation method is more efficient at lower frequencies and the second motor speed estimation method is more efficient at higher frequencies.

Both estimation methods have low quantization noise when n_{clk} or n_{ISR} are large numbers, i.e. └n_{clk}┘≈ n_{clk} and └n_{ISR}┘≈n_{ISR}, respectively. The quantization errors for both estimation methods can be calculated based on (5) as follows:

$$\{ \begin{matrix}{\tilde{f}}_{1} & = f * - {\hat{f}}_{1} = f * - \frac{{f}_{clk} / {N}_{0}}{⌊ {f}_{clk} / ( {N}_{0} f * ) ⌋} \\ {\tilde{f}}_{2} & = f * - {\hat{f}}_{2} = f * - \frac{⌊ ( {N}_{0} f \text{*)} / {f}_{ISR} ⌋}{{N}_{0} / {f}_{ISR}}\end{matrix} \qquad ( 7 )$$

Normalized quantization errors as percentages can be expressed as follows:

$$\{ \begin{matrix}{\tilde{f}}_{1}^{\%} & = \frac{{\tilde{f}}_{1}}{f *} = 1 - \frac{{f}_{clk} / ( {N}_{0} f \text{*)}}{⌊ {f}_{clk} / ( {N}_{0} f * ) ⌋} \\ {\tilde{f}}_{2}^{\%} & = \frac{{\tilde{f}}_{2}}{f *} = 1 - \frac{⌊ ( {N}_{0} f \text{*)} / {f}_{ISR} ⌋}{( {N}_{0} f \text{*)} / {f}_{ISR}}\end{matrix} \qquad ( 8 )$$

where

$${\tilde{f}}_{1}^{\%}$$

is the normalized error percentage for the first motor speed estimation method and

$${\tilde{f}}_{2}^{\%}$$

is the normalized quantization error percentage for the second motor speed estimation method.

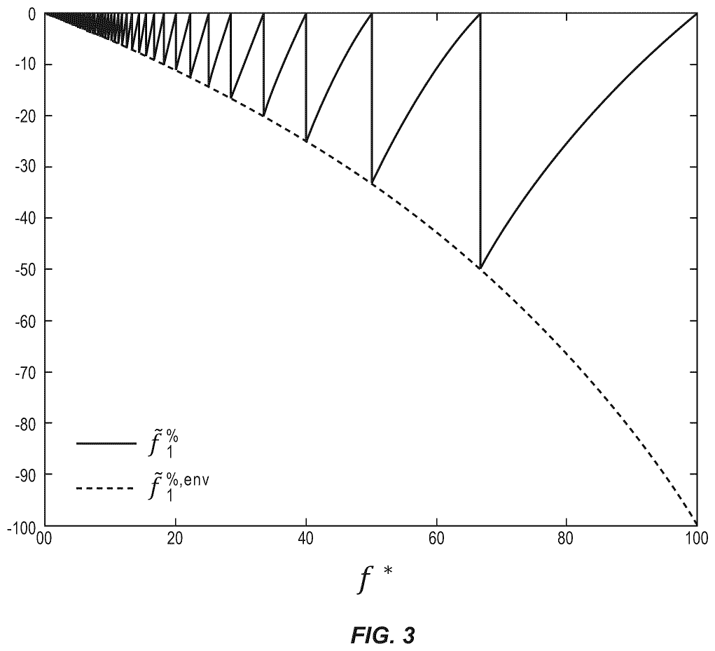

FIG. 3 illustrates a normalized quantization error

$${\tilde{f}}_{1}^{\%}$$

and normalized quantization error envelope

$${\tilde{f}}_{1}^{\% , env}$$

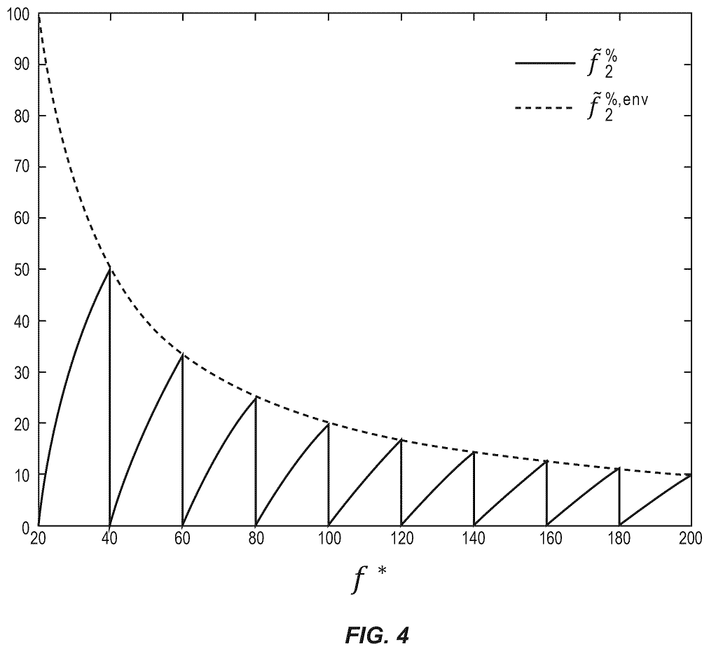

for the first motor speed estimation method, with an example encoder having N₀=500, f_{clk}=100 kHz, and f_{ISR}=10 kHz. In this example, f_{clk}=100 kHz is lower than normal to easily demonstrate the effects of the motor speed estimation technique. The fixed clock frequency f_{clk} of the timer/counter 114 is more typically in the MHz range. FIG. 4 illustrates a normalized quantization error

$${\tilde{f}}_{2}^{\%}$$

the and normalized quantization error envelope

$${\tilde{f}}_{2}^{\% , env}$$

for the second motor speed estimation method and for the same example encoder parameters used in FIG. 3.

As seen in FIGS. 3 and 4, the normalized error curves are discontinuous for both motor speed estimation methods. However, the envelope curves

$${\tilde{f}}_{1}^{\% , env} and {\tilde{f}}_{2}^{\% , env}$$

may be considered because they are continuous. The analytical equation for these curves can be obtained by considering the maximum quantization error which can be created by the floor function, i.e. └x┘=x−1, as follows:

$$\{ \begin{matrix}{\tilde{f}}_{1}^{\% , env} & = 1 - \frac{{f}_{clk} / ( {N}_{0} f * )}{{f}_{clk} / ( {N}_{0} f \text{*)} - 1} \\ {\tilde{f}}_{2}^{\% , env} & = 1 - \frac{( {N}_{0} f \text{*)} / {f}_{ISR} - 1}{( {N}_{0} f \text{*)} / {f}_{ISR}}\end{matrix} \qquad ( 9 )$$

which results in:

$$\{ \begin{matrix}{\tilde{f}}_{1}^{\% , env} = - \frac{{N}_{0} {f}^{*}}{{f}_{clk} - {N}_{0} {f}^{*}} \leq 0 \\ {\tilde{f}}_{2}^{\% , env} = \frac{{f}_{ISR}}{{N}_{0} {f}^{*}} \geq 0\end{matrix} \qquad ( 10 )$$

According to (10), the first motor speed estimation method has −∞ error at f*=f_{clk}/N₀ and the second motor speed estimation method has +∞ error at f*=0.

The quantization error curves for both motor speed estimation methods demonstrate that the error of the first motor speed estimation method is always negative and the error of the second motor speed estimation method is always positive. The quantization error curves also demonstrate that the error magnitude for the first motor speed estimation method becomes smaller at lower frequencies and the error magnitude for the second motor speed estimation method becomes smaller at higher frequencies.

The motor speed estimation technique described herein leverages both of these characteristics to significantly reduce the motor speed estimation error, by weighting (blending) the estimation results of both methods based on rotor mechanical frequency. The motor speed estimation technique described herein also allows for quantization-noise shaping, which can significantly reduce the quantization noise in measuring the motor speed without any changes in hardware or requiring more costly higher precision encoders.

A first embodiment of the motor speed estimation technique described herein involves a binary weighting decision. According to this embodiment, the official estimate \hat{f} of the rotor mechanical frequency f* is dynamically revised by determining a breakeven point between both motor speed estimation methods. In one embodiment, the breakeven point is implemented as a predetermined frequency threshold

$${f}_{thresh}^{*} .$$

For rotor mechanical frequencies above the threshold

$${f}_{thresh}^{*}$$

(breakeven point), the controller 100 uses the second motor speed estimation method. For rotor mechanical frequencies below the threshold

$${f}_{thresh}^{*}$$

(breakeven point), the controller 100 uses the first motor speed estimation method.

The threshold frequency

$${f}_{thresh}^{*}$$

can be calculated by equating the absolute values of normalized error envelopes as follows:

$$\vert {\tilde{f}}_{1}^{\% , env} \vert = \vert {\tilde{f}}_{2}^{\% , env} \vert ⇒ \frac{{f}_{ISR}}{{N}_{0} {f}^{*}} = \frac{{N}_{0} {f}^{*}}{{f}_{clk} - {N}_{0} {f}^{*}} \qquad ( 11 )$$

which results in a quadratic equation that can be solved to obtain the threshold frequency

$${f}_{thresh}^{*}$$

as follows:

$${( {f}^{*} )}^{2} + ( \frac{{f}_{ISR}}{{N}_{0}} ) {f}^{*} - ( \frac{{f}_{clk} {f}_{ISR}}{{N}_{0}^{2}} ) = 0 \qquad ( 12 )$$

$${f}_{thresh}^{*} = \frac{\sqrt{{f}_{ISR}^{2} + 4 {f}_{clk} {f}_{ISR}} - {f}_{ISR}}{2 {N}_{0}} \qquad ( 13 )$$

Since the clock frequency f_{clk} of the timer/counter 114 is usually much higher than f_{ISR} in practical applications, (13) can be approximated as:

$${f}_{thresh}^{*} \approx \frac{\sqrt{{f}_{clk} {f}_{ISR}}}{{N}_{0}} for {f}_{clk} ≫ {f}_{ISR} \qquad ( 14 )$$

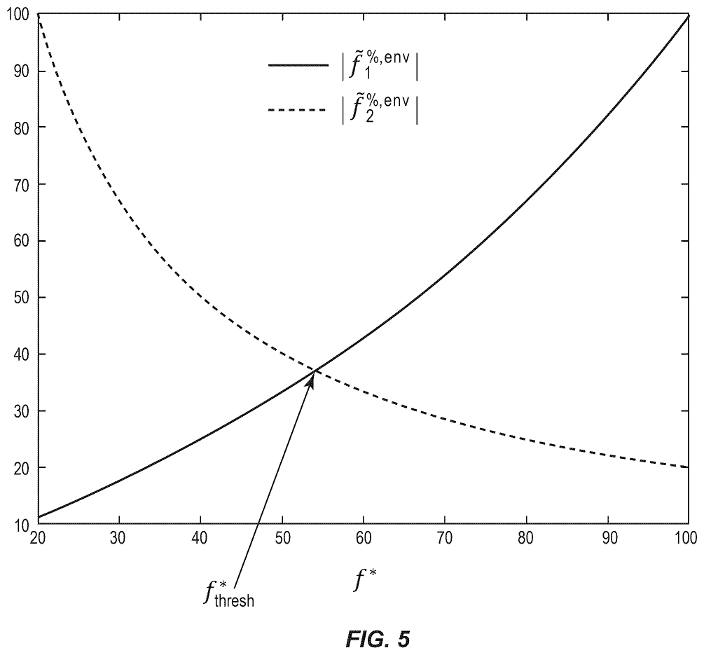

FIG. 5 illustrates the breakeven frequency point analysis described in (13), for an example encoder with N₀=500, f_{clk}=100 kHz, and f_{ISR}=10 kHz. FIG. 5 plots absolute values of normalized error envelopes and shows the breakeven point, i.e. predetermined frequency threshold

$${f}_{thresh}^{*}$$

where both motor speed estimation methods produce the same quantization noise error. To the right (higher frequencies) of the predetermined frequency threshold

$${f}_{thresh}^{*} ,$$

the first motor speed estimation method produces more quantization noise error than the second motor speed estimation method. To the left (lower frequencies) of the predetermined frequency threshold

$${f}_{thresh}^{*} .$$

the second motor speed estimation method produces more quantization noise error than the first motor speed estimation method.

During motor operation, the controller 100 applies a weighting factor of one to the first estimate \hat{f}₁ of the rotor mechanical frequency f* and a weighting factor of zero to the second estimate \hat{f}₂ of the rotor mechanical frequency f*, for rotor mechanical frequencies below the predetermined threshold

$${f}_{thresh}^{*} ,$$

For motor mechanical frequencies above the predetermined threshold

$${f}_{thresh}^{*} ,$$

the controller 100 applies weighting factor of one to the second estimate \hat{f}₂ of the rotor mechanical frequency f* and a weighting factor of zero to the first estimate \hat{f}₁ of the rotor mechanical frequency f*.

A second embodiment of the motor speed estimation technique described herein involves further reducing the quantization error by weighted blending of the results obtained from the first and second motor speed estimation methods at each frequency point. To derive an optimal blending curve, a general weighted blending with coefficients k₁ and k₂ can be represented as:

$$\{ \begin{matrix}\hat{f} = {k}_{1} {\hat{f}}_{1} + {k}_{2} {\hat{f}}_{2} \\ 1 = {k}_{1} + {k}_{2} ( isometric blend )\end{matrix} \qquad ( 15 )$$

If the weighted blending is isometric and does not change the scaling factor, i.e., 1=k₁+k₂, the real rotor mechanical frequency f* and frequency error \tilde{f} can be expressed similar to (15) as:

$$\{ \begin{matrix}{f}^{*} = {k}_{1} {f}^{*} + {k}_{2} {f}^{*} \\ \tilde{f} = {f}^{*} - f = {k}_{1} {\tilde{f}}_{1} + {k}_{2} {\tilde{f}}_{2}\end{matrix} \qquad ( 16 )$$

The cost function to minimize is:

$$\vert \tilde{f} \vert = \vert {k}_{1} {\tilde{f}}_{1} + {k}_{2} {\tilde{f}}_{2} \vert \to minimize \qquad ( 17 )$$

which is equivalent to minimizing the normalized cost function as follows:

$$\vert {\tilde{f}}^{\%} \vert = \vert {k}_{1} \frac{{\tilde{f}}_{1}}{{f}^{*}} + {k}_{2} \frac{{\tilde{f}}_{2}}{{f}^{*}} \vert = \vert {k}_{1} {\tilde{f}}_{1}^{\%} + {k}_{2} {\tilde{f}}_{2}^{\%} \vert \to minimize \qquad ( 18 )$$

Since 1=k₁+k₂, there is one degree of freedom:

$$\{ \begin{matrix}{k}_{2} = k \\ {k}_{1} = 1 - k\end{matrix} \qquad ( 19 )$$

In addition, the error polarities were previously established as opposite:

$$\{ \begin{matrix}{\tilde{f}}_{1}^{\% , env} \leq 0 \\ {\tilde{f}}_{2}^{\% , env} \geq 0\end{matrix} \qquad ( 20 )$$

Accordingly, the best solution can be obtained by setting the resulting error envelope to zero is:

$$( 1 - k ) {\tilde{f}}_{1}^{\% , env} + k {\tilde{f}}_{2}^{\% , env} = 0 \qquad ( 21 )$$

Consequently,

$$\begin{matrix}\frac{k}{1 - k} = \frac{- {\tilde{f}}_{1}^{\% , env}}{{\tilde{f}}_{2}^{\% , emv}} ⇒ \\ k = \frac{- {\tilde{f}}_{1}^{\% , env}}{{\tilde{f}}_{2}^{\% , env} - {\tilde{f}}_{1}^{\% , env}} = \frac{\vert {\tilde{f}}_{1}^{\% , env} \vert}{\vert {\tilde{f}}_{1}^{\% , env} \vert + \vert {\tilde{f}}_{2}^{\% , env} \vert}\end{matrix} \qquad ( 22 )$$

which results in:

$${k}_{opt} = \frac{{( {N}_{0} {f}^{*} )}^{2}}{{( {N}_{0} {f}^{*} )}^{2} + {f}_{ISR} ( {f}_{clk} - {N}_{0} {f}^{*} )} \qquad ( 23 )$$

Equation (23) describes the optimal blending curve which minimizes the quantization error. Equation (23) can be validated by evaluating both ends of the frequency spectrum as follows:

$${k}_{opt} = \{ \begin{matrix}0 & : {f}^{*} = 0 \\ 1 & : {f}^{*} = {f}_{clk} / {N}_{0}\end{matrix} \qquad ( 24 )$$

As seen in (24), when the quantization error of one of the methods is ∞, the optimal weighting/blending curve assigns a weight of 0 for that method, and when the quantization error of one of the methods is 0, the optimal weighting/blending curve assigns a weight of 1 for that method. Between these limits, the controller 100 weights the first and second estimates \hat{f}₁, \hat{f}₂ inversely proportional to one another based on the rotor mechanical frequency f*, by calculating a nonlinear weighting factor kₒₚₜ over a target frequency range, e.g. in accordance with equation (23) and applying the nonlinear weighting factor kₒₚₜ to the first and second estimates \hat{f}₁, \hat{f}₂ of the rotor mechanical frequency f*, as a function of frequency.

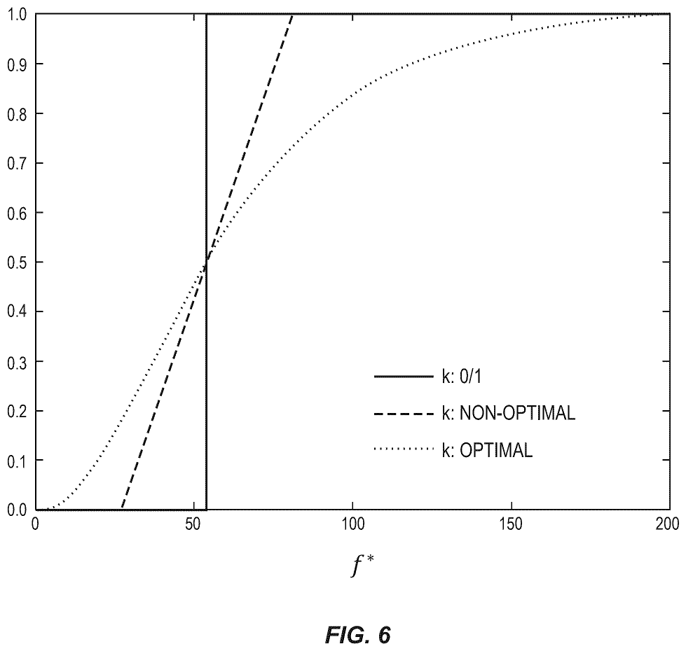

FIG. 6 illustrates the optimal weighting/blending curve (‘k: optimal’) described in equation (23). FIG. 6 also illustrates the simpler binary switching-type weighting/blending method (‘k: 0/1’) described above, and a third option that is similar to the optimal weighting/blending curve but instead uses a less computationally intensive linear curve fitting (‘k: non-optimal’).

The controller 100 may implement the third option, which uses linear curve fitting (‘k: non-optimal’), to dynamically revise the official estimate \hat{f} of the rotor mechanical frequency f*, by calculating a linear weighting factor based on the rotor mechanical frequency f* and applying the linear weighting factor to the first and second estimates \hat{f}₁, \hat{f}₂ of the rotor mechanical frequency f*. For example, the controller 100 may dynamically revise the official estimate \hat{f} of the rotor mechanical frequency f* as follows:

$$\begin{matrix}\tilde{f} = max ( min ( \frac{1}{2} + m ( {f}^{*} - {f}_{thresh}^{*} ) , 1 ) , 0 ) \\ {m \approx \frac{{dk}_{opt}}{{df}^{*}} \vert}_{{f}^{*} = {f}_{thresh}^{*}}\end{matrix} \qquad ( 25 )$$

where the linear weighting factor has a slope m that approximates the change

$$( \frac{{dk}_{opt}}{{df}^{*}} )$$

of the nonlinear weighting factor kₒₚₜ over a target frequency range.

The nonlinear weighting factor kₒₚₜ yields lower overall quantization error over the frequency range of interest compared to the linear weighting factor, but is more computationally involved. More generally, any curve that fits between the optimal weighting/blending curve (‘k: optimal’) and the binary switching-type weighting/blending method (‘k: 0/1’) shown in FIG. 6 may be used. FIG. 6 also shows that both the linear weighting factor (‘k: optimal’ curve) and the nonlinear weighting factor (‘k: non-optimal’ curve) have a positive slope.

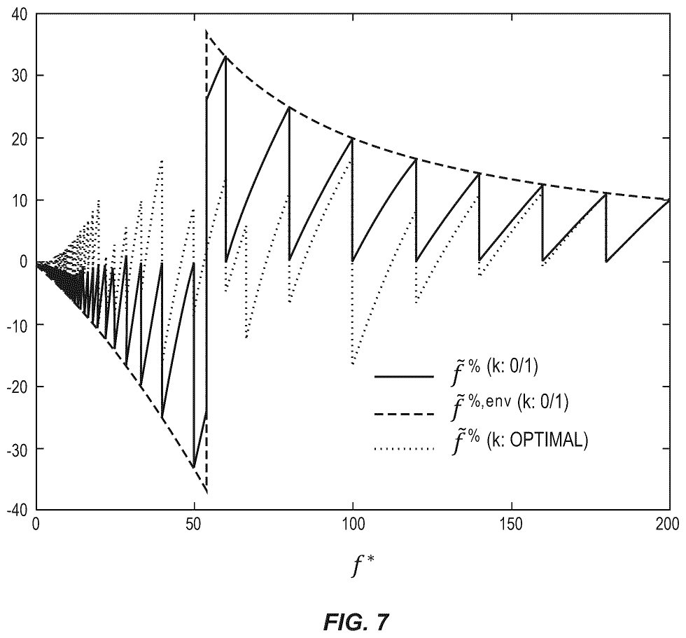

FIG. 7 illustrates the resulting normalized error curves obtained by the binary switching-type weighting/blending method (‘k: 0/1’) and the optimal weighting/blending curve (‘k: optimal’). As seen in FIG. 7, using the nonlinear weighting/blending method described by equation (23) results in significant reduction in overall quantization error compared to using the binary switching-type weighting/blending method. The nonlinear weighting/blending method also has better overall quantization error performance compared to the linear weighting/blending method (‘k: non-optimal’ curve in FIG. 6).

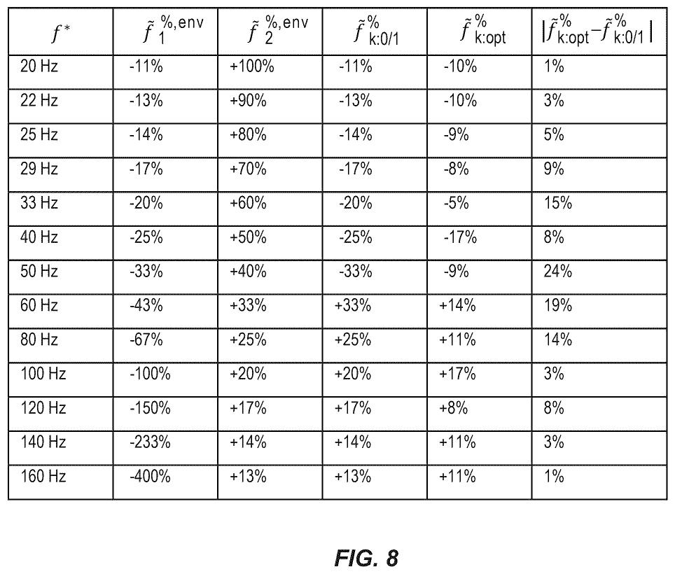

FIG. 8 illustrates a table of quantization error results obtained for an example encoder with N₀=500, f_{clk}=100 kHz, and f_{ISR}=10 kHz. Four different motor speed estimation methods are compared in FIG. 8: just the first motor speed estimation method (\tilde{f}₁); just the second motor speed estimation method (\tilde{f}₂); the binary switching-type weighting/blending method (\hat{f}_{k:0/1}); and the nonlinear weighting/blending method (\tilde{f}_{k:opt}). The last column in FIG. 8 shows the quantization error improvement between the binary switching-type weighting/blending method and the nonlinear weighting/blending method.

The nonlinear weighting/blending method described in equation (23) and the linear weighting/blending method described in equation (25) both use the estimated frequency f as an input to determine the blending weights. The output of both the nonlinear weighting/blending method and the linear weighting/blending method is the estimated frequency itself. Therefore, both of these methods utilize a closed loop system.

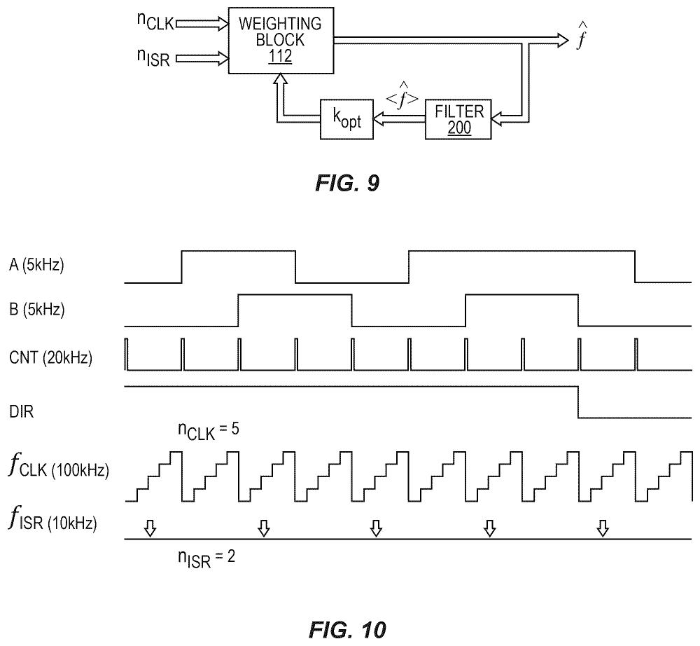

FIG. 9 illustrates a block diagram of an embodiment of the closed loop system. FIG. 10 illustrates the encoder signals A, B (each at 5 kHz), CNT (at 20 kHz), and DIR, and the frequency parameters f_{clk} and f_{ISR} for an example encoder with N₀=500, f_{clk}=100 kHz, and f_{ISR}=10 KHz.

According to this embodiment, the controller 100 includes a filter 200 that filters the official estimate \hat{f} of the rotor mechanical frequency f*. The first and second estimates \hat{f}₁, \hat{f}₂ of the rotor mechanical frequency f* are then weighted/blended by the controller weighting block 112 inversely proportional to one another based on the filtered official estimate [symbol] f [symbol] of the rotor mechanical frequency f*, as described in equation (23). Any low pass filter that provides enough attenuation for low frequency noise may be used to filter the official estimate \hat{f} of the rotor mechanical frequency f* as part of the closed loop system. Even a simple pass-through delay (z⁻¹) may be sufficient.

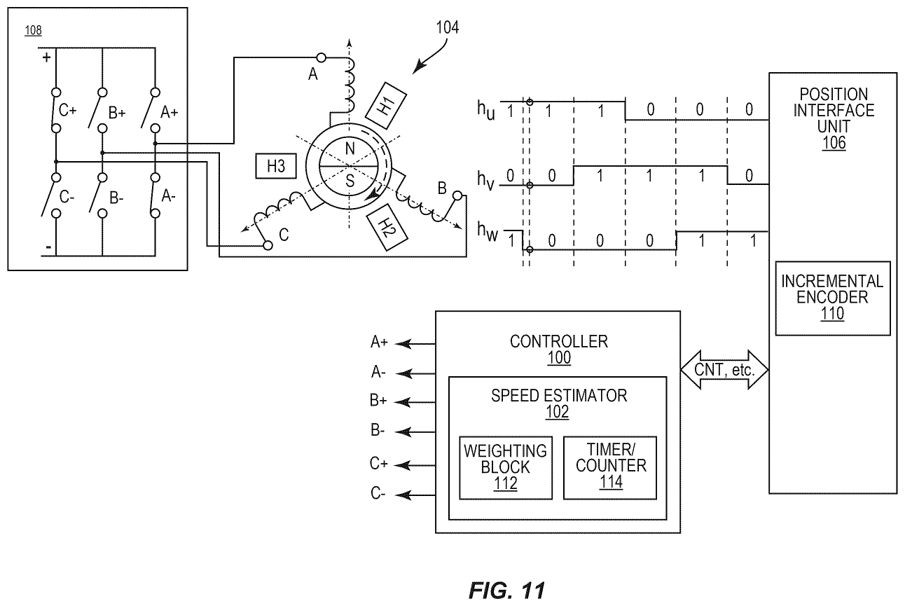

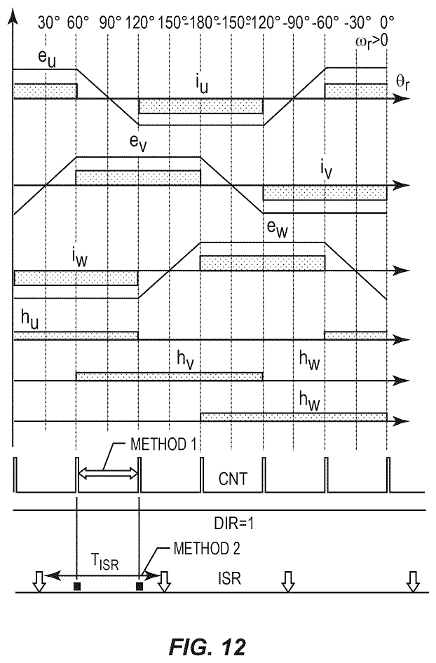

FIG. 11 illustrates a schematic diagram of the motor control system, according to another embodiment. The embodiment illustrated in FIG. 11 is similar to the embodiment illustrated in FIG. 1. In FIG. 11, the counter pulses CNT are derived from hall sensor signals hᵤ, hᵥ, h_{w} for each phase u, v, w of the motor 104 instead of from quadrature incremental encoder signals. The hall sensors H1, H2, H3 that produce the hall sensor signals hᵤ, hᵥ, h_{w} can be viewed as a type of encoder, where the hall sensors H1, H2, H3 typically have six (6) steps per revolution, i.e. CPR=6, as opposed to encoders with an arbitrary CPR (usually in the range of 1000). The hall signal patterns hᵤ, hᵥ, h_{w}, which are shown in FIG. 12, are different than incremental encoder signals but the resulting period and position capture principles are the same. Accordingly, the motor speed estimation techniques described herein can be applied to hall sensors in very high-speed applications, as indicated in FIGS. 11 and 12, where FIG. 12 also shows the corresponding currents iᵤ, iᵥ, i_{w} and voltages eᵤ, eᵥ, e_{w} for the respective phases u, v, w of the motor 104.

Although the present disclosure is not so limited, the following numbered examples demonstrate one or more aspects of the disclosure.

Example 1. A method of estimating motor speed, comprising: calculating a first estimate of rotor mechanical frequency of a motor based on measured time between successive counter pulses, wherein each of the counter pulses corresponds to a fixed number of counts per revolution of the motor; calculating a second estimate of the rotor mechanical frequency based on the number of counter pulses over a fixed period of time; and dynamically revising an official estimate of the rotor mechanical frequency, by weighting the first and second estimates inversely proportional to one another based on the rotor mechanical frequency.

Example 2. The method of example 1, wherein weighting the first and second estimates inversely proportional to one another based on the rotor mechanical frequency comprises: applying a weighting factor of one to the first estimate of the rotor mechanical frequency and a weighting factor of zero to the second estimate of the rotor mechanical frequency, for rotor mechanical frequencies below a predetermined threshold; and applying a weighting factor of one to the second estimate of the rotor mechanical frequency and a weighting factor of zero to the first estimate of the rotor mechanical frequency, for rotor mechanical frequencies above the predetermined threshold.

Example 3. The method of example 1, wherein weighting the first and second estimates inversely proportional to one another based on the rotor mechanical frequency comprises: calculating a linear weighting factor based on the rotor mechanical frequency; and applying the linear weighting factor to the first and second estimates of the rotor mechanical frequency.

Example 4. The method of example 3, wherein the linear weighting factor has a positive slope.

Example 5. The method of example 3 or 4, wherein the linear weighting factor has a slope that approximates change of a nonlinear weighting factor over a frequency range, and wherein the nonlinear weighting factor yields lower overall quantization error over the frequency range compared to the linear weighting factor.

Example 6. The method of example 1, wherein weighting the first and second estimates inversely proportional to one another based on the rotor mechanical frequency comprises: calculating a nonlinear weighting factor over a frequency range; and applying the nonlinear weighting factor to the first and second estimates of the rotor mechanical frequency, as a function of frequency.

Example 7. The method of example 6, wherein the nonlinear weighting factor is calculated as follows:

$${k}_{opt} = \frac{{( {N}_{0} {f}^{*} )}^{2}}{{( {N}_{0} {f}^{*} )}^{2} + {f}_{ISR} ( {f}_{clk} - {N}_{0} {f}^{*} )} ,$$

where kₒₚₜ is the nonlinear weighting factor, N₀ is the fixed number of counts per revolution of the motor, f_{ISR} is a frequency of the fixed period of time, f_{clk} is a clock frequency of a timer/counter that measures time between the successive counter pulses, and f* is the rotor mechanical frequency.

Example 8. The method of any of examples 1 through 7, wherein the counter pulses are derived from incremental encoder quadrature signals.

Example 9. The method of any of examples 1 through 7, wherein the counter pulses are derived from hall sensor signals.

Example 10. The method of any of examples 1 through 9, further comprising: filtering the official estimate of the rotor mechanical frequency, wherein the first and second estimates of the rotor mechanical frequency are weighted inversely proportional to one another based on the filtered official estimate of the rotor mechanical frequency.

Example 11. A motor control system, comprising a controller configured to: calculate a first estimate of rotor mechanical frequency of a motor based on measured time between successive counter pulses, wherein each of the counter pulses corresponds to a fixed number of counts per revolution of the motor; calculate a second estimate of the rotor mechanical frequency based on the number of counter pulses over a fixed period of time; and dynamically revise an official estimate of the rotor mechanical frequency, by weighting the first and second estimates inversely proportional to one another based on the rotor mechanical frequency.

Example 12. The motor control system of example 11, wherein the controller is configured to: apply a weighting factor of one to the first estimate of the rotor mechanical frequency and a weighting factor of zero to the second estimate of the rotor mechanical frequency, for rotor mechanical frequencies below a predetermined threshold; and apply a weighting factor of one to the second estimate of the rotor mechanical frequency and a weighting factor of zero to the first estimate of the rotor mechanical frequency, for rotor mechanical frequencies above the predetermined threshold.

Example 13. The motor control system of example 11, wherein the controller is configured to: calculate a linear weighting factor based on the rotor mechanical frequency; and apply the linear weighting factor to the first and second estimates of the rotor mechanical frequency.

Example 14. The motor control system of example 13, wherein the linear weighting factor has a positive slope.

Example 15. The motor control system of example 13 or 14, wherein the linear weighting factor has a slope that approximates change of a nonlinear weighting factor over a frequency range, and wherein the nonlinear weighting factor yields lower overall quantization error over the frequency range compared to the linear weighting factor.

Example 16. The motor control system of example 11, wherein the controller is configured to: calculate a nonlinear weighting factor over a frequency range; and apply the nonlinear weighting factor to the first and second estimates of the rotor mechanical frequency, as a function of frequency.

Example 17. The motor control system of example 16, wherein the controller is configured to calculate the nonlinear weighting factor as follows:

$${k}_{opt} = \frac{{( {N}_{0} {f}^{*} )}^{2}}{{( {N}_{0} {f}^{*} )}^{2} + {f}_{ISR} ( {f}_{clk} - {N}_{0} {f}^{*} )} ,$$

where kₒₚₜ is the nonlinear weighting factor, N₀ is the fixed number of counts per revolution of the motor, f_{ISR} is a frequency of the fixed period of time, f_{clk} is a clock frequency of a timer/counter that measures time between the successive counter pulses, and f* is the rotor mechanical frequency.

Example 18. The motor control system of any of examples 11 through 17, wherein the controller is configured to derive the counter pulses from incremental encoder quadrature signals.

Example 19. The motor control system of any of examples 11 through 17, wherein the controller is configured to derive the counter pulses from hall sensor signals.

Example 20. The motor control system of any of examples 11 through 19, wherein the controller is configured to: filter the official estimate of the rotor mechanical frequency; and weight the first and second estimates of the rotor mechanical frequency inversely proportional to one another based on the filtered official estimate of the rotor mechanical frequency.

Terms such as “first”, “second”, and the like, are used to describe various elements, regions, sections, etc. and are also not intended to be limiting. Like terms refer to like elements throughout the description.

As used herein, the terms “having”, “containing”, “including”, “comprising” and the like are open ended terms that indicate the presence of stated elements or features, but do not preclude additional elements or features. The articles “a”, “an” and “the” are intended to include the plural as well as the singular, unless the context clearly indicates otherwise.

The expression “and/or” should be interpreted to cover all possible conjunctive and disjunctive combinations, unless expressly noted otherwise. For example, the expression “A and/or B” should be interpreted to mean A but not B, B but not A, or both A and B. The expression “at least one of” should be interpreted in the same manner as “and/or”, unless expressly noted otherwise. For example, the expression “at least one of A and B” should be interpreted to mean A but not B, B but not A, or both A and B.

It is to be understood that the features of the various embodiments described herein can be combined with each other, unless specifically noted otherwise.

Although specific embodiments have been illustrated and described herein, it will be appreciated by those of ordinary skill in the art that a variety of alternate and/or equivalent implementations can be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method of estimating motor speed, comprising:
calculating a first estimate of rotor mechanical frequency of a motor based on measured time between successive counter pulses, wherein each of the counter pulses corresponds to a fixed number of counts per revolution of the motor;
calculating a second estimate of the rotor mechanical frequency based on the number of counter pulses over a fixed period of time; and
dynamically revising an official estimate of the rotor mechanical frequency, by weighting the first and second estimates inversely proportional to one another based on the rotor mechanical frequency.

2. The method of claim 1, wherein weighting the first and second estimates inversely proportional to one another based on the rotor mechanical frequency comprises:
applying a weighting factor of one to the first estimate of the rotor mechanical frequency and a weighting factor of zero to the second estimate of the rotor mechanical frequency, for rotor mechanical frequencies below a predetermined threshold; and
applying a weighting factor of one to the second estimate of the rotor mechanical frequency and a weighting factor of zero to the first estimate of the rotor mechanical frequency, for rotor mechanical frequencies above the predetermined threshold.

3. The method of claim 1, wherein weighting the first and second estimates inversely proportional to one another based on the rotor mechanical frequency comprises:
calculating a linear weighting factor based on the rotor mechanical frequency; and
applying the linear weighting factor to the first and second estimates of the rotor mechanical frequency.

4. The method of claim 3, wherein the linear weighting factor has a positive slope.

5. The method of claim 3, wherein the linear weighting factor has a slope that approximates change of a nonlinear weighting factor over a frequency range, and wherein the nonlinear weighting factor yields lower overall quantization error over the frequency range compared to the linear weighting factor.

6. The method of claim 1, wherein weighting the first and second estimates inversely proportional to one another based on the rotor mechanical frequency comprises:
calculating a nonlinear weighting factor over a frequency range; and
applying the nonlinear weighting factor to the first and second estimates of the rotor mechanical frequency, as a function of frequency.

7. The method of claim 6, wherein the nonlinear weighting factor is calculated as follows:
$${k}_{opt} = \frac{{( {N}_{0} {f}^{*} )}^{2}}{{( {N}_{0} {f}^{*} )}^{2} + {f}_{ISR} ( {f}_{clk} - {N}_{0} {f}^{*} )} ,$$
where kₒₚₜ is the nonlinear weighting factor, N₀ is the fixed number of counts per revolution of the motor, f_{ISR} is a frequency of the fixed period of time, f_{clk} is a clock frequency of a timer/counter that measures time between the successive counter pulses, and f* is the rotor mechanical frequency.

8. The method of claim 1, wherein the counter pulses are derived from incremental encoder quadrature signals.

9. The method of claim 1, wherein the counter pulses are derived from hall sensor signals.

10. The method of claim 1, further comprising:
filtering the official estimate of the rotor mechanical frequency,
wherein the first and second estimates of the rotor mechanical frequency are weighted inversely proportional to one another based on the filtered official estimate of the rotor mechanical frequency.

11. A motor control system, comprising:
a controller configured to:
calculate a first estimate of rotor mechanical frequency of a motor based on measured time between successive counter pulses, wherein each of the counter pulses corresponds to a fixed number of counts per revolution of the motor;
calculate a second estimate of the rotor mechanical frequency based on the number of counter pulses over a fixed period of time; and
dynamically revise an official estimate of the rotor mechanical frequency, by weighting the first and second estimates inversely proportional to one another based on the rotor mechanical frequency.

12. The motor control system of claim 11, wherein the controller is configured to:
apply a weighting factor of one to the first estimate of the rotor mechanical frequency and a weighting factor of zero to the second estimate of the rotor mechanical frequency, for rotor mechanical frequencies below a predetermined threshold; and
apply a weighting factor of one to the second estimate of the rotor mechanical frequency and a weighting factor of zero to the first estimate of the rotor mechanical frequency, for rotor mechanical frequencies above the predetermined threshold.

13. The motor control system of claim 11, wherein the controller is configured to:
calculate a linear weighting factor based on the rotor mechanical frequency; and
apply the linear weighting factor to the first and second estimates of the rotor mechanical frequency.

14. The motor control system of claim 13, wherein the linear weighting factor has a positive slope.

15. The motor control system of claim 13, wherein the linear weighting factor has a slope that approximates change of a nonlinear weighting factor over a frequency range, and wherein the nonlinear weighting factor yields lower overall quantization error over the frequency range compared to the linear weighting factor.

16. The motor control system of claim 11, wherein the controller is configured to:
calculate a nonlinear weighting factor over a frequency range; and
apply the nonlinear weighting factor to the first and second estimates of the rotor mechanical frequency, as a function of frequency.

17. The motor control system of claim 16, wherein the controller is configured to calculate the nonlinear weighting factor as follows:
$${k}_{opt} = \frac{{( {N}_{0} {f}^{*} )}^{2}}{{( {N}_{0} {f}^{*} )}^{2} + {f}_{ISR} ( {f}_{clk} - {N}_{0} {f}^{*} )} ,$$
where kₒₚₜ is the nonlinear weighting factor, No is the fixed number of counts per revolution of the motor, f_{ISR} is a frequency of the fixed period of time, f_{clk} is a clock frequency of a timer/counter that measures time between the successive counter pulses, and f* is the rotor mechanical frequency.

18. The motor control system of claim 11, wherein the controller is configured to derive the counter pulses from incremental encoder quadrature signals.

19. The motor control system of claim 11, wherein the controller is configured to derive the counter pulses from hall sensor signals.

20. The motor control system of claim 11, wherein the controller is configured to:
filter the official estimate of the rotor mechanical frequency; and
weight the first and second estimates of the rotor mechanical frequency inversely proportional to one another based on the filtered official estimate of the rotor mechanical frequency.
